(19) United States
(12) Patent Application Publication
(10) Pub. No.: US 2021/0099756 A1
(43) Pub. Date: Apr. 1, 2021

(54) LOW-COST VIDEO SEGMENTATION

(71) Applicant: QUALCOMM Incorporated, San Diego, CA (US)

(72) Inventors: Darren Gnanapragasam, Aurora (CA); George SHEHATA, Richmond Hill (CA); Adrian LEUNG, Richmond Hill (CA); Alireza SHOA HASSANI LASHDAN, Burlington (CA); Evgenii KRASNIKOV, Etobicoke (CA); David HANSEN, Calgary (CA)

(21) Appl. No.: 16/589,379

(22) Filed: Oct. 1, 2019

(51) Int. Cl. H04N 21/44; H04N 5/232; G06K 9/00; H04N 21/472; G06T 7/20; H04N 21/845

(52) U.S. Cl. CPC H04N 21/44008; H04N 5/23251; H04N 21/8456; H04N 21/472; G06T 7/20; G06K 9/00711

(57) ABSTRACT

Methods, systems, and devices for low-cost video segmentation are described. A media file may include multiple frames. Information for pixels in a first frame and pixels in a subsequent frame may be discarded based on segmentation maps computed for the first and subsequent frame. After discarding the pixel information, motion information may be determined for the remaining pixels in the first and subsequent frame. The segmentation maps generated for the first and subsequent frames and the determined motion information may be used to compute one or more additional segmentation maps for one or more additional frames that are temporally located between the first and subsequent frame. After computing segmentation maps for all or a portion of the frames in the media file, a modified version of the frames may be output based on the computed segmentation maps.

### BACKGROUND

The following relates generally to media processing, and more specifically to low-cost video segmentation.

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

In some cases, manipulating multimedia information may include adding effects to media (e.g., converting portions of a color video to black and white). Techniques for reducing the computational load associated with adding effects to media may be desired.

### SUMMARY

The described techniques relate to improved methods, systems, devices, and apparatuses that support low-cost video segmentation. Video segmentation may involve the computerized identification and classification of particular objects (e.g., humans, cars, background, etc.) within a frame or video. Low-cost video segmentation may involve techniques that use reduced computational resources in the identification and classification of the particular objects.

In some cases, in “key frames” (e.g., every fourth frame), information for pixels that are not associated with a first classification may be discarded, resulting in “masked key frames.” The classification of the pixels may be based on segmentation maps generated for respective key frames (which may be referred to as “key segmentation maps”). Consecutive masked key frames may be compared to determine a single set of motion and/or occlusion information. The single set of motion and occlusion information and the key segmentation maps may be used to generate segmentation maps for frames occurring between consecutive key frames (which may be referred to as “intervening frames”, “non-key frames,” or “intervening non-key frames”). By discarding information for a portion of the pixels in key frames, the determination of the motion and occlusion information may be simplified—e.g., because computations for determining such information may be performed for a reduced number of pixels. Also, by generating a single set of motion and occlusion information for a group of intervening non-key frames, rather than multiple sets of motion and occlusion information, the computational load on a graphics processing unit (GPU) may be reduced.

A method of media processing at a device is described. The method may include discarding information for a first set of pixels in a first frame and a second set of pixels in a second frame based on a first segmentation map for the first frame and a second segmentation map for the second frame, determining motion information for a third set of pixels in the first frame and a fourth set of pixels in the second frame based on the discarding, computing, based on the first segmentation map, the second segmentation map, and the motion information, a third segmentation map for a third frame that is temporally located between the first frame and the second frame, and outputting a modified version of the third frame based on the third segmentation map.

An apparatus for media processing at a device is described. The apparatus may include a processor, memory in electronic communication with the processor, and instructions stored in the memory. The instructions may be executable by the processor to cause the apparatus to discard information for a first set of pixels in a first frame and a second set of pixels in a second frame based on a first segmentation map for the first frame and a second segmentation map for the second frame, determine motion information for a third set of pixels in the first frame and a fourth set of pixels in the second frame based on the discarding, compute, based on the first segmentation map, the second segmentation map, and the motion information, a third segmentation map for a third frame that is temporally located between the first frame and the second frame, and output a modified version of the third frame based on the third segmentation map.

Another apparatus for media processing at a device is described. The apparatus may include means for discarding information for a first set of pixels in a first frame and a second set of pixels in a second frame based on a first segmentation map for the first frame and a second segmentation map for the second frame, means for determining motion information for a third set of pixels in the first frame and a fourth set of pixels in the second frame based on the discarding, means for computing, based on the first segmentation map, the second segmentation map, and the motion information, a third segmentation map for a third frame that is temporally located between the first frame and the second frame, and means for outputting a modified version of the third frame based on the third segmentation map.

A non-transitory computer-readable medium storing code for media processing at a device is described. The code may include instructions executable by a processor to discard information for a first set of pixels in a first frame and a second set of pixels in a second frame based on a first segmentation map for the first frame and a second segmentation map for the second frame, determine motion information for a third set of pixels in the first frame and a fourth set of pixels in the second frame based on the discarding, compute, based on the first segmentation map, the second segmentation map, and the motion information, a third segmentation map for a third frame that is temporally located between the first frame and the second frame, and output a modified version of the third frame based on the third segmentation map.

Some examples of the method, apparatuses, and non-transitory computer-readable medium described herein may further include operations, features, means, or instructions for computing the first segmentation map for the first frame and the second segmentation map for the second frame, where, in the first segmentation map, a first classification may be assigned to the third set of pixels of the first frame, and in the second segmentation map, the first classification may be assigned to the fourth set of pixels of the second frame, and comparing the first segmentation map with the first frame and the second segmentation map with the second frame, where discarding the information for the first set of pixels in the first frame and the second set of pixels in the second frame may be based on the comparing.

In some examples of the method, apparatuses, and non-transitory computer-readable medium described herein, in the first segmentation map, a second classification may be assigned to the first set of pixels of the first frame, and in the second segmentation map, the second classification may be assigned to the second set of pixels of the second frame. Some examples of the method, apparatuses, and non-transitory computer-readable medium described herein may further include operations, features, means, or instructions for determining that the first set of pixels of the first frame and the second set of pixels of the second frame may be associated with the second classification based on the first segmentation map and the second segmentation map, where discarding the information for the first set of pixels and the second set of pixels may be based on the determining.

In some examples of the method, apparatuses, and non-transitory computer-readable medium described herein, comparing the first segmentation map with the first frame and the second segmentation map with the second frame may include operations, features, means, or instructions for superimposing the first segmentation map over the first frame and the second segmentation map over the second frame, and discarding the information for the first set of pixels in the first frame and the second set of pixels in the second frame includes discarding, in the first frame, pixels that do not overlap with pixels classified in the first segmentation map as the first classification, and in the second frame, pixels that do not overlap with pixels classified in the second segmentation map as the first classification.

Some examples of the method, apparatuses, and non-transitory computer-readable medium described herein may further include operations, features, means, or instructions for computing, based on the first segmentation map, the second segmentation map, and the motion information, a fourth segmentation map for a fourth frame that may be temporally located between the first frame and the second frame.

Some examples of the method, apparatuses, and non-transitory computer-readable medium described herein may further include operations, features, means, or instructions for estimating, between the first frame and the second frame, a motion of an object displayed by the third set of pixels in the first frame and the fourth set of pixels in the second frame based on the motion information determined for the third set of pixels and the fourth set of pixels, and where computing the third segmentation map includes: interpolating the third segmentation map based on the estimated motion of the object; where the interpolation may be from one or more of: the first segmentation map or the second segmentation map.

Some examples of the method, apparatuses, and non-transitory computer-readable medium described herein may further include operations, features, means, or instructions for determining occlusion information for the third set of pixels in the first frame and the fourth set of pixels in the second frame based on the discarding, where the third segmentation map may be computed based on the occlusion information.

In some examples of the method, apparatuses, and non-transitory computer-readable medium described herein, determining the motion information or the occlusion information, or both, for the third set of pixels in the first frame and the fourth set of pixels in the second frame may include operations, features, means, or instructions for comparing information of the third set of pixels with information of the fourth set of pixels.

Some examples of the method, apparatuses, and non-transitory computer-readable medium described herein may further include operations, features, means, or instructions for outputting modified versions of the first frame and the second frame based on the first segmentation map and the second segmentation map.

Some examples of the method, apparatuses, and non-transitory computer-readable medium described herein may further include operations, features, means, or instructions for displaying the modified versions of the first frame, second frame, and third frame, where the modified versions of the first frame, the second frame, and the third frame may include a foreground portion and a background portion that is displayed in a different manner than the foreground portion.

Some examples of the method, apparatuses, and non-transitory computer-readable medium described herein may further include operations, features, means, or instructions for storing a media file including multiple frames. Some examples of the method, apparatuses, and non-transitory computer-readable medium described herein may further include operations, features, means, or instructions for obtaining a media file including multiple frames.

### BRIEF DESCRIPTION OF THE DRAWINGS

FIG. 1 shows aspects of an exemplary multimedia system that supports low-cost video segmentation as disclosed herein.

FIG. 2 shows aspects of an exemplary device that supports low-cost video segmentation as disclosed herein.

FIG. 3 shows aspects of an exemplary media processing system that supports low-cost video segmentation as disclosed herein.

FIG. 4 shows aspects of an exemplary process for low-cost video segmentation as disclosed herein.

FIG. 5 shows a block diagram of an exemplary device that supports low-cost video segmentation as disclosed herein.

FIG. 6 shows a block diagram of an exemplary multimedia manager that supports low-cost video segmentation as disclosed herein.

FIG. 7 shows a flowchart illustrating an exemplary method that supports low-cost video segmentation as disclosed herein.

### DETAILED DESCRIPTION

Adding effects to media may involve identifying particular objects within the media before adjusting the media itself—e.g., adding an effect that converts a background of a video to black and white while objects in the foreground retain their color may first involve identifying objects in the foreground. One technique for identifying particular objects in a frame involves using fully convolutional neural networks to assign segmentation classes (e.g., “human” class) to each pixel in a frame and then grouping contiguous pixels sharing a segmentation class to form an object of the segmentation class (e.g., a human). This technique may be referred to as “pixel-wise semantic segmentation.”

In some examples, pixel-wise semantic segmentation may involve inputting a frame into a fully convolutional neural network, where the fully convolutional neural network outputs a segmentation map for the inputted frame. The segmentation map may include segmentation class information for each pixel in the frame. In some cases, the segmentation map may be configured to keep information only for pixels corresponding to one or more classes (e.g., for pixels classified as “human”), isolating the selected classified pixels from other classified pixels (e.g., isolating “human” pixels from “background” pixels).

When adding effects to video, using fully convolutional neural networks to generate a segmentation map for each frame in the video may be computationally intensive, especially as the frame rate (measured in frames per second (FPS)) of the video increases. To reduce the computational load, the fully convolutional neural network may be run for a subset of the video's frames (referred to as “key” frames) and motion vectors may be computed for the frames in between the key frames (referred to as “intervening” or “non-key” frames). For example, for a particular non-key frame (e.g., frame 2) located between two consecutive key frames (e.g., frame 1 and frame 5), a fully convolutional neural network may be used to generate segmentation maps for the consecutive key frames and a motion estimate may be generated for objects in the particular non-key frame using the first key frame, the particular non-key frame, and the second key frame. After computing the motion estimate for the particular non-key frame, the motion estimate and the segmentation maps generated for the consecutive key frames may be used to generate a segmentation map for the non-key frame using less computational resources than if the fully convolutional neural network were used to generate a segmentation map for the non-key frame.

Despite reducing the computational load, using motion information to generate segmentation maps for non-key frames still uses considerable computational resources because motion estimates are determined for each pixel in each non-key frame. Also, under this approach, objects that are fully or partially blocked in one frame (or “occluded objects”) may be difficult to detect when an object's initial movement and/or uncovering begins within non-key frames, resulting in the misclassification of pixels.

One technique for reducing the computational load and increasing the accuracy of pixel classification includes discarding, for key frames, information for pixels that are not associated with a particular classification based on a segmentation map that has been generated for the key frames using a fully convolutional neural network. The version of the key frames including discarded pixel information may be referred to as “masked key frames.” After discarding the pixel information, consecutive masked key frames may be used to determine motion information for the remaining pixels in the masked key frames whose information has been retained. The determined motion information and segmentation maps for the corresponding consecutive key frames may then be used to generate segmentation maps for the intervening non-key frames occurring between consecutive key frames. Then, during playback of media including the key and non-key frames, the display of the key frames and the intervening non-key frames may be modified based on the generated segmentation maps.

For example, a first segmentation map may be generated for a first key frame (e.g., frame 1) and a second segmentation map may be generated for a second key frame (e.g., frame 5). Accordingly, particular pixels in the key frames may be classified according to the respective segmentation map. For instance, pixels in a key frame displaying a “person” may be identified and tagged as making up a person while other pixels in the key frame may be identified and tagged as “background” (e.g., pixels displaying permanent fixtures, such as buildings, sidewalks, street signs, etc.). The classification information for each pixel in the key frames may be represented by a respective segmentation map.

Next, a “mask” may be applied to the first key frame and the second key frame based on the first and second segmentation maps, respectively. That is, information for pixels associated with a particular classification (e.g., “human”) in the key frames may be retained while pixels associated with other classifications (e.g., “background”) in the key frames may be discarded—e.g., by setting color, motion, and/or occlusion information associated with the pixels to zero—reducing the complexity of the key frames. Pixels associated with the particular classification that remain after the mask is applied may be referred to as “uncovered pixels.”

After the mask is applied to the first and second key frames, the first masked key frame and the second masked key frame may be compared with one another to obtain a motion estimate and/or occlusion information for the uncovered pixels. A motion estimate may include velocity information for a portion of an object displayed by a pixel and may be used to predict whether or how much of the portion of the object the pixel will continue to be displayed in a consecutive frame. Occlusion information may include computed values that are used to detect pixels displaying objects that were previously blocked or obscured by other objects (or “occluded pixels”).

By comparing the first masked key frame with the second masked key frame to obtain motion information, one motion estimate may be determined for all of the intervening non-key frames—rather than a motion estimate for each of the intervening non-key frames—reducing the computational load. Also, by comparing the first masked key frame with the second masked key frame to obtain occlusion information, occluded areas may be detected with increased accuracy because the detection may not use information derived from less accurate non-key frames and the masking process may facilitate the computation of motion vectors. Moreover, by masking portions of the first and second key frames, the number of pixels for which motion estimates and occlusion information is computed may be reduced, further reducing the computational load.

After obtaining the motion estimate and/or occlusion information for the uncovered pixels, the motion estimate, occlusion information, and the first and/or second segmentation maps may be used to generate segmentation maps for intervening non-key frames. Generating a third segmentation map for an intervening non-key frame (e.g., frame 2) may include interpolating (or “shifting”) values of the first segmentation map based on the motion estimate. For instance, the classification information for certain pixels representing the first segmentation map may be modified based on the estimated motion of an object of a particular class—e.g., a pixel may be reclassified from “human” to “background” or vice versa. Similarly, the third segmentation map may be generated by shifting values of the fourth segmentation map based on the motion estimate.

As suggested above, computing motion estimates for each non-key frame may be computationally intensive. Thus, in some cases, the computational load may be reduced and without performing a masking step. That is, in some cases, segmentation maps may be generated for key frames, and consecutive, uncovered key frames may be compared with one another to obtain a single motion estimate. The segmentation maps for the key frames and single motion estimate may then be used to generate segmentation maps for the intervening non-key frames as discussed above. By using a single motion estimate for intervening non-key frames, less motion estimates may be computed and the computational load may be reduced.

Aspects of the disclosure are initially described in the context of a multimedia system. Specific examples are then described of devices and media processing systems that support low-cost video segmentation. Aspects of the disclosure are further illustrated by and described with reference to apparatus diagrams, system diagrams, and flowcharts that relate to low-cost video segmentation.

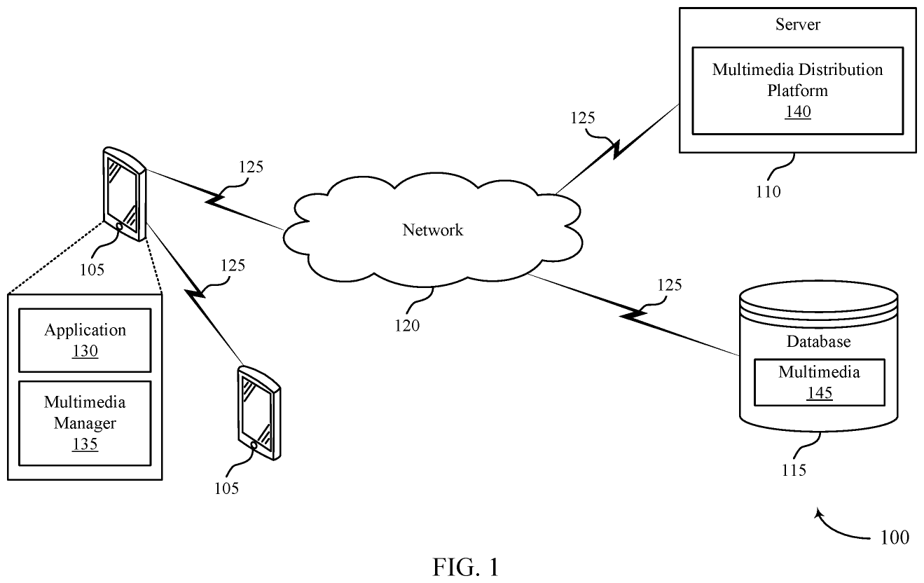

FIG. 1 shows aspects of an exemplary multimedia system that supports low-cost video segmentation as disclosed herein.

A multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. The devices 105, the server 110, and the database 115 may communicate with each other and exchange information that supports low-cost video segmentation, such as multimedia packets, multimedia data, or multimedia control information, via network 120 using communications links 125. In some cases, a portion or all of the techniques described herein supporting low-cost video segmentation may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130 and a multimedia manager 135. While the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) or transmit (e.g., upload) multimedia data from or to the server 110, the database 115, or to another device 105 via using communications links 125.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support low-cost video segmentation, according to the techniques described herein.

The server 110 may be a data server, a cloud server, a server associated with a multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support low-cost video segmentation associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The communication links 125 may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some cases, the multimedia system 100 may be configured to process a media file (e.g., a video file), which may include adding audio or visual effects to the media file. Processing the media file may include comparing key frames to determine motion and/or occlusion information and generating a motion estimate and/or detecting occluded objects based on the motion and/or occlusion information. In some cases, a motion estimate and/or occlusion detection for consecutive key frames may be used to generate segmentation maps for intervening non-key frames located between consecutive key frames. By using a single motion estimate for the intervening non-key frames, less motion estimates may be computed and the computational load at multimedia system may be reduced.

In some examples, before the key frames are compared, processing the media file may include discarding information for pixels in key frames based on segmentation maps generated for the corresponding key frames. Accordingly, the version of the key frames including discarded pixel information (or “masked key frames”) may be compared. By comparing masked key frames, motion and/or occlusion information may be computed only for the remaining pixels and the computational load may be reduced.

In some cases, all or a portion of the processing of the media file may occur at the server 110, on the network 120, at a device 105, or any combination thereof. In some examples, all or a portion of the processing may be performed by multimedia manager 135. In some examples, the processed media file may be displayed at one or more of devices 105.

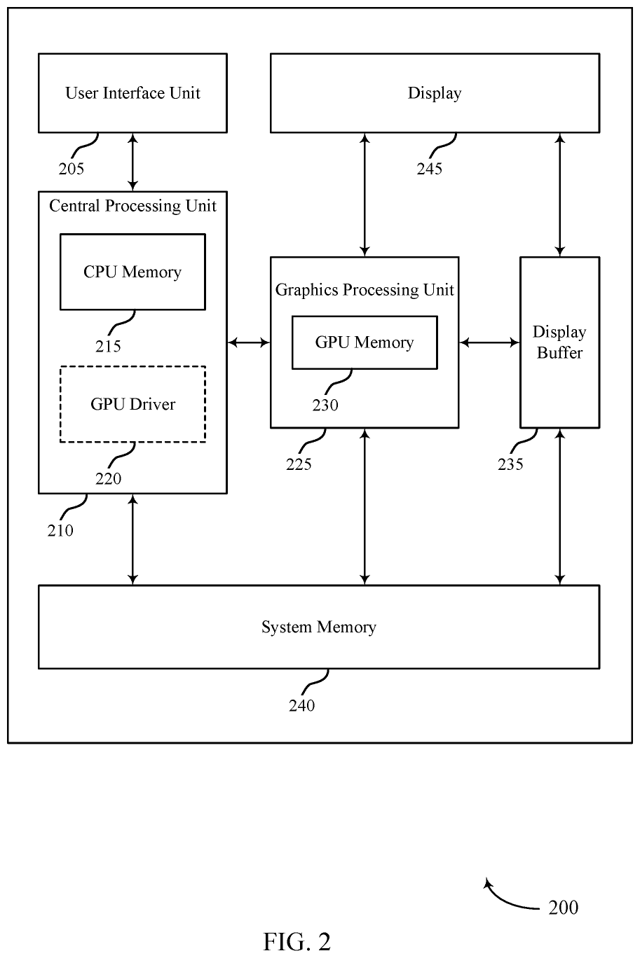

FIG. 2 shows aspects of an exemplary device that supports low-cost video segmentation as disclosed herein.

In some cases, device 200 may be an example of a device 105 of FIG. 1. Examples of device 200 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 2, device 200 includes a central processing unit (CPU) 210 having CPU memory 215, a GPU 225 having GPU memory 230, a display 245, a display buffer 235 storing data associated with rendering, a user interface unit 205, and a system memory 240. For example, system memory 240 may store a GPU driver 220 (illustrated as being contained within CPU 210 as described below) having a compiler, a GPU program, a locally-compiled GPU program, and the like. User interface unit 205, CPU 210, GPU 225, system memory 240, and display 245 may communicate with each other (e.g., using a system bus).

Examples of CPU 210 include, but are not limited to, a digital signal processor (DSP), general purpose microprocessor, ASIC, FPGA, or other equivalent integrated or discrete logic circuitry. Although CPU 210 and GPU 225 are illustrated as separate units in the example of FIG. 2, in some examples, CPU 210 and GPU 225 may be integrated into a single unit. CPU 210 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 245. As illustrated, CPU 210 may include CPU memory 215. For example, CPU memory 215 may represent on-chip storage or memory used in executing machine or object code. CPU memory 215 may include one or more volatile or non-volatile memories or storage devices, such as flash memory, a magnetic data media, an optical storage media, etc. CPU 210 may be able to read values from or write values to CPU memory 215 more quickly than reading values from or writing values to system memory 240, which may be accessed, e.g., over a system bus. In some cases, CPU 210 may include, or be an example of, multimedia manager 135 of FIG. 1.

GPU 225 may represent one or more dedicated processors for performing graphical operations. That is, for example, GPU 225 may be a dedicated hardware unit having fixed function and programmable components for rendering graphics and executing GPU applications. GPU 225 may also include a DSP, a general purpose microprocessor, an ASIC, an FPGA, or other equivalent integrated or discrete logic circuitry. GPU 225 may be built with a highly-parallel structure that provides more efficient processing of complex graphic-related operations than CPU 210. For example, GPU 225 may include a plurality of processing elements that are configured to operate on multiple vertices or pixels in a parallel manner. The highly parallel nature of GPU 225 may allow GPU 225 to generate graphic images (e.g., graphical user interfaces and two-dimensional or three-dimensional graphics scenes) for display 245 more quickly than CPU 210.

GPU 225 may, in some instances, be integrated into a motherboard of device 200. In other instances, GPU 225 may be present on a graphics card that is installed in a port in the motherboard of device 200 or may be otherwise incorporated within a peripheral device configured to interoperate with device 200. As illustrated, GPU 225 may include GPU memory 230. For example, GPU memory 230 may represent on-chip storage or memory used in executing machine or object code. GPU memory 230 may include one or more volatile or non-volatile memories or storage devices, such as flash memory, a magnetic data media, an optical storage media, etc. GPU 225 may be able to read values from or write values to GPU memory 230 more quickly than reading values from or writing values to system memory 240, which may be accessed, e.g., over a system bus. That is, GPU 225 may read data from and write data to GPU memory 230 without using the system bus to access off-chip memory. This operation may allow GPU 225 to operate in a more efficient manner by reducing the need for GPU 225 to read and write data via the system bus, which may experience heavy bus traffic.

Display 245 represents a unit capable of displaying video, images, text or any other type of data for consumption by a viewer. Display 245 may include a liquid-crystal display (LCD), a light emitting diode (LED) display, an organic LED (OLED), an active-matrix OLED (AMOLED), or the like. Display buffer 235 represents a memory or storage device dedicated to storing data for presentation of imagery, such as computer-generated graphics, still images, video frames, or the like for display 245. Display buffer 235 may represent a two-dimensional buffer that includes a plurality of storage locations. The number of storage locations within display buffer 235 may, in some cases, generally correspond to the number of pixels to be displayed on display 245. For example, if display 245 is configured to include 640×480 pixels, display buffer 235 may include 640×480 storage locations storing pixel color and intensity information, such as red, green, and blue pixel values, or other color values. Display buffer 235 may store the final pixel values for each of the pixels processed by GPU 225. Display 245 may retrieve the final pixel values from display buffer 235 and display the final image based on the pixel values stored in display buffer 235.

User interface unit 205 represents a unit with which a user may interact with or otherwise interface to communicate with other units of device 200, such as CPU 210. Examples of user interface unit 205 include, but are not limited to, a trackball, a mouse, a keyboard, and other types of input devices. User interface unit 205 may also be, or include, a touch screen and the touch screen may be incorporated as part of display 245.

System memory 240 may comprise one or more computer-readable storage media. Examples of system memory 240 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 240 may store program modules and/or instructions that are accessible for execution by CPU 210. Additionally, system memory 240 may store user applications and application surface data associated with the applications. System memory 240 may in some cases store information for use by and/or information generated by other components of device 200. For example, system memory 240 may act as a device memory for GPU 225 and may store data to be operated on by GPU 225 as well as data resulting from operations performed by GPU 225.

In some examples, system memory 240 may include instructions that cause CPU 210 or GPU 225 to perform the functions ascribed to CPU 210 or GPU 225 in aspects of the present disclosure. System memory 240 may, in some examples, be considered as a non-transitory storage medium. The term “non-transitory” should not be interpreted to mean that system memory 240 is non-movable. As one example, system memory 240 may be removed from device 200 and moved to another device. As another example, a system memory substantially similar to system memory 240 may be inserted into device 200. In certain examples, a non-transitory storage medium may store data that can, over time, change (e.g., in RAM).

System memory 240 may store a GPU driver 220 and compiler, a GPU program, and a locally-compiled GPU program. The GPU driver 220 may represent a computer program or executable code that provides an interface to access GPU 225. CPU 210 may execute the GPU driver 220 or portions thereof to interface with GPU 225 and, for this reason, GPU driver 220 is shown in the example of FIG. 2 within CPU 210. GPU driver 220 may be accessible to programs or other executables executed by CPU 210, including the GPU program stored in system memory 240. Thus, when one of the software applications executing on CPU 210 requires graphics processing, CPU 210 may provide graphics commands and graphics data to GPU 225 for rendering to display 245 (e.g., via GPU driver 220).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 225 to execute commands without user knowledge as to the specifics of the hardware components. In order to process the graphics rendering instructions, CPU 210 may issue one or more rendering commands to GPU 225 (e.g., through GPU driver 220) to cause GPU 225 to perform some or all of the rendering of the graphics data. In some examples, the graphics data to be rendered may include a list of graphics primitives (e.g., points, lines, triangles, quadrilaterals, etc.).

The GPU program stored in system memory 240 may invoke or otherwise include one or more functions provided by GPU driver 220. CPU 210 generally executes the program in which the GPU program is embedded and, upon encountering the GPU program, passes the GPU program to GPU driver 220. CPU 210 executes GPU driver 220 in this context to process the GPU program. That is, for example, GPU driver 220 may process the GPU program by compiling the GPU program into object or machine code executable by GPU 225. This object code may be referred to as a locally-compiled GPU program. In some examples, a compiler associated with GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 210 and GPU 225).

In the example of FIG. 2, the compiler may receive the GPU program from CPU 210 when executing HL code that includes the GPU program. That is, a software application being executed by CPU 210 may invoke GPU driver 220 (e.g., via a graphics API) to issue one or more commands to GPU 225 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 225 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 220 may formulate one or more commands that specify one or more operations for GPU 225 to perform in order to render the primitive. When GPU 225 receives a command from CPU 210, it may decode the command and configure one or more processing elements to perform the specified operation and may output the rendered data to display buffer 235.

GPU 225 generally receives the locally-compiled GPU program, and then, in some instances, GPU 225 renders one or more images and outputs the rendered images to display buffer 235. For example, GPU 225 may generate a number of primitives to be displayed at display 245. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 225 for display as an image (or frame in the context of video data) via display 245. GPU 225 may transform primitives and other attributes (e.g., that define a color, texture, lighting, camera configuration, or other aspect) of the primitives into a so-called “world space” by applying one or more model transforms (which may also be specified in the state data). Once transformed, GPU 225 may apply a view transform for the active camera (which again may also be specified in the state data defining the camera) to transform the coordinates of the primitives and lights into the camera or eye space. GPU 225 may also perform vertex shading to render the appearance of the primitives in view of any active lights. GPU 225 may perform vertex shading in one or more of the above model, world, or view space.

Once the primitives are shaded, GPU 225 may perform projections to project the image into a canonical view volume. After transforming the model from the eye space to the canonical view volume, GPU 225 may perform clipping to remove any primitives that do not at least partially reside within the canonical view volume. That is, GPU 225 may remove any primitives that are not within the frame of the camera. GPU 225 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 225 may then rasterize the primitives. Generally, rasterization may refer to the task of taking an image described in a vector graphics format and converting it to a raster image (e.g., a pixelated image) for output on a video display or for storage in a bitmap file format.

A GPU 225 may include a dedicated fast bin buffer (e.g., a fast memory buffer, such as GMEM, which may be referred to by GPU memory 230). As discussed herein, a rendering surface may be divided into bins. In some cases, the bin size is determined by format (e.g., pixel color and depth information) and render target resolution divided by the total amount of GMEM. The number of bins may vary based on device 200 hardware, target resolution size, and target display format. A rendering pass may draw (e.g., render, write, etc.) pixels into GMEM (e.g., with a high bandwidth that matches the capabilities of the GPU). The GPU 225 may then resolve the GMEM (e.g., burst write blended pixel values from the GMEM, as a single layer, to a display buffer 235 or a frame buffer in system memory 240). Such may be referred to as bin-based or tile-based rendering. When all bins are complete, the driver may swap buffers and start the binning process again for a next frame.

For example, GPU 225 may implement a tile-based architecture that renders an image or rendering target by breaking the image into multiple portions, referred to as tiles or bins. The bins may be sized based on the size of GPU memory 230 (e.g., which may alternatively be referred to herein as GMEM or a cache), the resolution of display 245, the color or Z precision of the render target, etc. When implementing tile-based rendering, GPU 225 may perform a binning pass and one or more rendering passes. For example, with respect to the binning pass, GPU 225 may process an entire image and sort rasterized primitives into bins.

In some examples, CPU 210 may be configured to generate a motion estimate for and/or detect occluded object in consecutive key frames of a media file by processing information for pixels in the consecutive key frames. CPU 210 may be further configured to use the motion information and/or occlusion detection to generate interpolated segmentation maps for intervening non-key frames occurring between the consecutive key frames. By generating a single motion estimate for all of the intervening non-key frames, the number of generated motion estimates and the computational load at CPU 210 may be reduced.

In some examples, before generating the motion estimate, CPU 210 may be configured to mask the key frames by comparing the key frames with respective segmentation maps and discarding information for pixels in the key frames that are not classified as a particular class by the respective segmentation maps. By discarding the pixels before the comparison, the number of pixels processed by and the computational load at CPU 210 may be reduced.

In some cases, after processing the media file, CPU 210 may provide the processed media file to GPU 225, which may supply the processed media file to display 245. And display 245 may display the processed media file to a user of device 200.

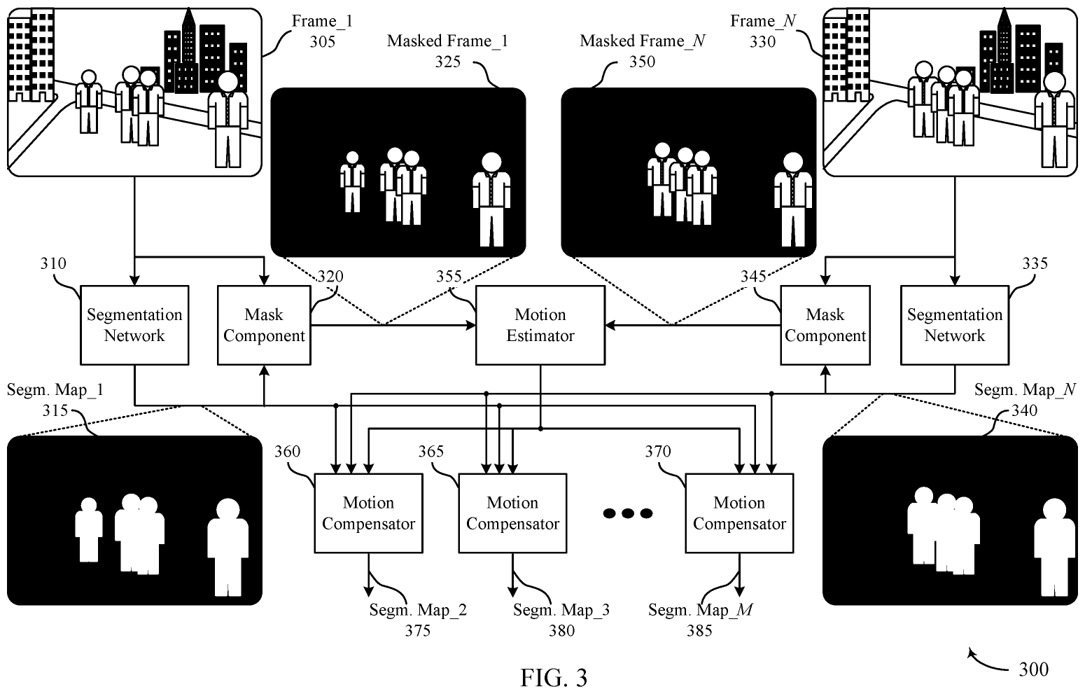

FIG. 3 shows aspects of an exemplary media processing system that supports low-cost video segmentation as disclosed herein.

Media processing system 300 may be configured to process and modify (e.g., add effects to) media files that include multiple frames. Media processing system 300 may include first segmentation network 310, first mask component 320, second segmentation network 335, second mask component 345, motion estimator 355, first motion compensator 360, second motion compensator 365, and Mth motion compensator 370. In some cases, media processing system 300 may be included in or implemented by CPU 210 of FIG. 2 or multimedia manager 135 of FIG. 1.

In some cases, media processing system 300 may be configured to process multiple frames in a video file, including first frame 305 (i.e., Frame_1), Nth frame 330 (i.e., Frame_N), and frames temporally located between first frame 305 and Nth frame 330 (e.g., Frames_2 to M, where M may equal N−1). In some cases, first frame 305 and Nth frame 330 are referred to as consecutive “key video frames,” and frames occurring between first frame 305 and Nth frame 330 are referred to as “intervening non-key video frames.” Media processing system 300 may be further configured to output segmentation maps for multiple frames—e.g., first segmentation map 315, second segmentation map 375, third segmentation map 380, Mth segmentation map 385 (where M may equal N−1), and Nth segmentation map 340 (where N may equal 5).

First segmentation network 310 may be configured to process key video frames and to identify or classify particular types of objects in the key video frames. For example, first segmentation network 310 may be configured to identify objects in a video frame that are—or classify objects in the video frame as—“foreground,” “human,” “automobiles,” “background,” etc., or any combination thereof. In some examples, first segmentation network 310 may analyze and classify each pixel in a received key video frame. After processing a key video frame (e.g., first frame 305), first segmentation network 310 may output a segmentation map (e.g., first segmentation map 315) based on the classification of objects in the video frame. The segmentation map may isolate certain classified objects from other classified objects. In some examples, the segmentation map may isolate a particular class of object (e.g., “human”) by discarding information for portions of (or pixels in) the video frame that are not classified as being of that particular class. Second segmentation network 335 may be similarly configured to process key video frames (e.g., Nth frame 330).

First mask component 320 may be configured to discard information for a portion of the pixels in a key video frame (e.g., first frame 305) based on a segmentation map generated for the key video frame (e.g., first segmentation map 315). For example, first mask component 320 may determine which pixels in a key video frame are associated with a particular type of object (e.g., human) based on a segmentation map for the key video frame. And after identifying the pixels in the key video frame that are associated with the object, first mask component 320 may discard information for all of the other pixels in the key video frame—i.e., first mask component 320 may keep only information for the pixels in the key video frame that have been classified as a particular type of object (e.g., may keep only pixels that display parts of a human). After discarding information for all of the other pixels in the key video frame, first mask component 320 may output a masked version of the key video frame (e.g., first masked frame 325). Second mask component 345 may be similarly configured to discard information for a portion of pixels in a key video frame (e.g., Nth frame 330) to generate a masked version of the key video frame (e.g., Nth masked frame 350).

Motion estimator 355 may be configured to determine motion information for objects that are in one or multiple video frames by comparing masked versions of key video frames. For example, motion estimator 355 may determine a velocity for a portion of an object that is present in two masked key video frames by comparing a location of one or more pixels displaying the portion of the object in a first masked key video frame with a location of one or more pixels displaying the portion of the object in a second masked key video frame.

In some cases, media processing system also includes an occlusion detection component that is configured to determine occlusion information for objects that are in one or multiple key video frames. For example, occlusion detection component may determine when an object that is hidden behind one object in a key video frame using the generated segmentation maps of consecutive key video frames.

First motion compensator 360 may be configured to generate a segmentation map for an intervening non-key video frame (e.g., a second frame that occurs between first frame 305 and Nth frame 330, which may be referred to as Frame_2). In some examples, the segmentation maps generated by first motion compensator 360 may be referred to as “intervening non-key segmentation maps.” First motion compensator 360 may generate the intervening non-key segmentation map based on a motion estimate generated by motion estimator 355, first segmentation map 315, and/or Nth segmentation map 340. In some cases, first motion compensator 360 generates a segmentation map by interpolating from a key frame using a motion estimate received from motion estimator 355. In some examples, first motion compensator 360 is further configured to generate an intervening non-key segmentation map using occlusion information determined by the occlusion detection component. Second motion compensator 365 and Mth motion compensator 370 may be similarly configured to generate segmentation maps for intervening non-key frames (e.g., frames that occur between first frame 305 and Nth frame 330).

As discussed herein, computing individual motion estimates for each intervening frame, and for each pixel in each intervening, may be computationally intensive. Moreover, the segmentation maps generated using such a technique may be less effective for detecting occluded objects. To reduce the computational load and to increase the accuracy of occlusion detection, a media processing system may use key frames to compute a single motion estimate that is used to generate the segmentation maps for all of the intervening frames. Also, to further reduce the computational load and increase accuracy of occlusion detection, the media processing may discard information for certain pixels in key frames before computing the single motion estimate.

For example, media processing system 300 may receive a video file including multiple frames including first frame 305, Nth frame 330 and one or more frames located between first frame 305 and Nth frame 330. In some cases, each of the frames consists of a certain number of pixels (e.g., 1,080 lines of 1,920 pixels).

After receiving the video file, media processing system 300 may process and/or add effects to the video file—e.g., media processing system may modify the video file from its original version. Processing the video file may include receiving first frame 305 at first segmentation network 310. First segmentation network 310 may process first frame 305 and may classify each of the pixels in first frame 305. In some examples, first segmentation network 310 may identify objects in first frame 305 that resemble people and may classify the pixels that make up the people as “human” pixels. After classifying the pixels, first segmentation network 310 may generate first segmentation map 315 for the classified objects and isolate the classified objects from the rest of the objects in first frame 305—e.g., first segmentation map may keep information only for the “human” classified pixels.

After generating first segmentation map 315, first segmentation network 310 may provide (e.g., signal) first segmentation map 315 to first mask component 320. Before, contemporaneously with, or after receiving first segmentation map 315, first mask component 320 may also receive first frame 305. Once first mask component 320 has both first frame 305 and first segmentation map 315, first mask component 320 may determine which pixels in first frame 305 are classified in accordance with the objects identified by first segmentation network 310. In some cases, first mask component 320 identifies which pixels have been classified by superimposing first segmentation map 315 over first frame 305 and determining which pixels in first frame 305 overlap with the classified pixels in first segmentation map 315. In other cases, first mask component 320 determines which pixels in first frame 305 were not classified by matching the pixels that were not classified in first segmentation map 315 with the corresponding pixels in first frame 305.

After identifying which pixels in first frame 305 were classified, first mask component 320 may discard information for the remaining pixels—i.e., the pixels that were not classified—while retaining all or a portion of the information for the classified pixels. Discarding the information for the remaining pixels may include discarding color, motion, and occlusion information associated with the unclassified pixels. After discarding the information for the unclassified pixels, first mask component 320 may output first masked frame 325 (i.e., the masked version of first frame 305) that depicts only detailed versions of the classified objects.

Similarly, second segmentation network 335 and second mask component 345 may process Nth frame 330, generating Nth segmentation map 340 and Nth masked frame 350. Nth segmentation map may identify objects of the same class as first segmentation map 315. And Nth masked frame 350 may depict only the detailed version of the objects identified by second segmentation network 335. By processing first frame 305 and Nth frame 330 in segmentation networks, and not the intervening frames, media processing system 300 may reduce the computational load for adding effects to a video file—e.g., by running full segmentation networks on a reduced number of frames. However, segmentation maps for the intervening non-key frames may also be computed to output a more complete version of the modified media file.

To compute segmentation maps for the intervening frames at a reduced computational load, media processing system 300 may use a motion estimate to predict the motion of objects through intervening non-key frames. Determining the motion estimate may include comparing, by motion estimator 355, a location of objects in first frame 305 with a location of the same objects in Nth frame 330. In some cases, motion estimator 355 compares first masked frame 325 with Nth masked frame 350 to generate a motion estimate for objects in one or both of first frame 305 and Nth frame 330. In some cases, the motion estimate includes speed, velocity, and directional information for an object. By comparing masked versions of first frame 305 and Nth frame 330, the computational load at motion estimator 355 may be further reduced—e.g., because less pixels are processed. Also, the accuracy of the motion estimate may be increased by isolating the desired objects because a clearer distinction of motion vectors associated with the classified objects and other objects may be obtained.

After computing the motion estimate for the unmasked objects, motion estimator 355 may provide the motion estimate to motion compensators that are configured to generate segmentation maps for each of the intervening frames. That is, motion estimator 355 may signal the motion estimate to first motion compensator 360, second motion compensator 365, Mth motion compensator 370, and any motion compensators located between second motion compensator 365 and Mth motion compensator 370. By providing a single motion estimate to each motion estimator associated with an intervening frames, the architecture of media processing system 300 may be simplified—e.g., by reducing the number of signal paths. Moreover, by computing a single motion estimate that is used for each intervening frame, the computational load at media processing system 300 may be reduced—e.g., by reducing the number of motion estimates that are computed.

Before, concurrently with, or after receiving the motion estimate from motion estimator 355, each of the motion compensators may receive first segmentation map 315 and Nth segmentation map 340. The motion compensators may then interpolate from first segmentation map 315 and/or Nth segmentation map 340 based on the motion estimate to generate intermediary segmentation maps—i.e., second segmentation map 375, third segmentation map 380, and Mth segmentation map 385. For instance, first motion compensator 360 may use a location of the one or more objects classified in first segmentation map 315 and the motion estimate to predict a second location of the one or more objects in second segmentation map 375. Additionally or alternatively, first motion compensator may use a location of the one or more objects classified in Nth segmentation map 340 and the motion estimate to predict a third location of the one or more objects in second segmentation map 375, Second motion compensator 365 and Mth motion compensator 370 may similarly predict new locations of objects in third segmentation map 380 and Mth segmentation map 385, respectively.

In some examples, the segmentation maps computed for the intervening frames may be generated based on occlusion information determined for first masked frame 325 and Nth masked frame 350. By using first masked frame 325 and Nth masked frame 350, occlusion detection may be more accurate—e.g., because the classified objects are separated from the other objects before occlusion information is generated, resulting in better separation of classified objects from other objects that may interfere with obtaining occlusion information. In some examples, an occlusion detection component may use the key and intervening non-key segmentation maps to determine occlusion information for the classified objects. That is, the occlusion detection component may use the segmentation maps to determine whether an object was blocked in first frame 305 or uncovered in Nth frame 330, or vice versa.

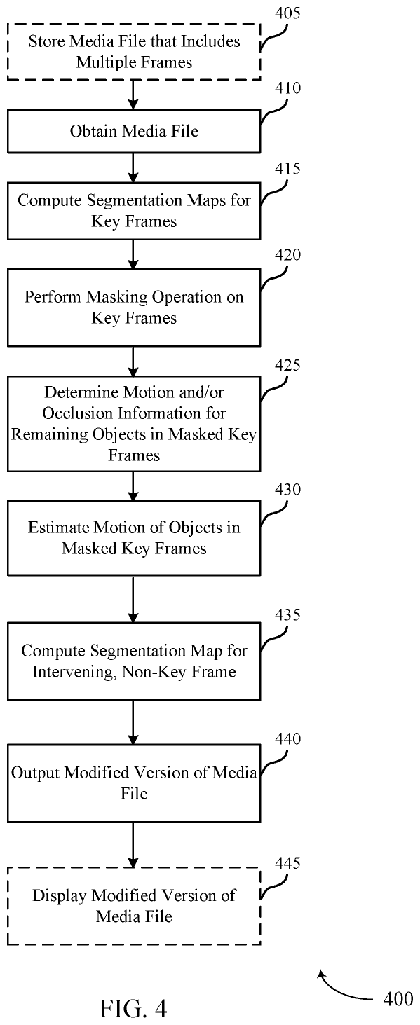

FIG. 4 shows aspects of an exemplary process for low-cost video segmentation as disclosed herein.

Flow chart 400 may be performed by components of a media processing system, such as media processing system 300 of FIG. 3. In some examples, flow chart 400 depicts aspects of a method for creating a modified version of a video file using reduced computational resources e.g., by applying masks to certain video frames.

At block 405, a media file may be stored in memory (e.g., external or internal to a media processing device). In some cases, the media file is a video file consisting of a large number of video frames where each video frame may be composed of, or represented by, a multiple pixels. In some cases, the media file may be stored externally from a device that includes the media processing system (e.g., on the cloud).

At block 410, a component of the media processing system may obtain the media file (e.g., from an external device or from internal memory). In some cases, obtaining the media file includes receiving the media file and a request to modify the media file. In some cases, the request may direct the media processing system to add a particular effect to the media file e.g., to color the background of the video black and white while retaining color in the foreground.

At block 415, a component of the media processing system (e.g., first segmentation network 310 and/or second segmentation network 335 of FIG. 3) may compute segmentation maps for key frames of the media file. For example, the media processing system may compute segmentation maps for every fourth frame of the media file. In some cases, a first segmentation map is computed for a first frame of the media file (e.g., Frame_1) and an Nth segmentation map is computed for an Nth frame of the media file (e.g., Frame_N, where N may equal 5). Computing the first segmentation map may include assigning a first classification (e.g., foreground) to a first set of pixels in the first frame and a second classification (e.g., background) to a second set of pixels in the first key frame. Computing the Nth segmentation map may include assigning the first classification to a third set of pixels in the Nth frame and the second classification to a fourth set of pixels in the Nth frame. In some cases, the determination that the second set of pixels and the fourth set of pixels are associated with the second classification is made based on determining that the first set of pixels and the third set of pixels are associated with the first classification—i.e., all pixels that are not classified with the first classification are classified as the second classification.

At block 420, a component of the media processing system (e.g., first mask component 320 or second mask component 345 of FIG. 3) may perform a masking operation on the key frames of the media file. Performing the masking operation may include comparing the first segmentation map with the first frame and the Nth segmentation map with the Nth frame. Comparing the first segmentation map with the first frame and the Nth segmentation map with the Nth frame may include superimposing the first segmentation map over the first frame and the Nth segmentation map over the Nth frame and identifying non-overlapping pixels. In another example, comparing the first segmentation map with the first frame and the Nth segmentation map with the Nth frame may include mapping pixels of the first classification in the first segmentation map with corresponding pixels in the first frame and pixels of the first classification in the Nth segmentation map with corresponding pixels in the Nth frame. By comparing the key frames with their respective segmentation maps, pixels in the key frames that were not classified with a particular classification may be identified. For example, the media processing system may determine that the second set of pixels in the first frame and the fourth set of pixels in the Nth frame were not assigned the first classification.

After identifying which pixels were not assigned the first classification, information for those pixels (e.g., pixels associated with no or another classification) may be discarded. That is, information for the second set of pixels in the first frame and the fourth set of pixels in the Nth frame may be discarded. Discarding the information for the pixels may include discarding color, motion, and/or occlusion information for the pixels. By discarding information for the second set of pixels and the fourth set of pixels, the computational load for subsequent processing of the masked key frames may be reduced—e.g., because motion and/or occlusion information may not be calculated for the discarded pixels.

At block 425, a component of the media processing system (e.g., motion estimator 355 of FIG. 3) may determine motion information for the remaining pixels in the masked key frames—e.g., for the first set of pixels in the first frame and the third set of pixels in the Nth frame. In some cases, determining motion information for the remaining pixels in the masked key frames includes comparing information of the first set of pixels in the first masked frame with information of the third set of pixels in the consecutive, Nth masked frame. By determining motion information for the first and third set of pixels, motion estimates of an object displayed by these pixels may be obtained. Also, more accurate motion estimates may be obtained for objects by isolating the classified objects before performing the motion estimate—e.g., because the objects are clearly separated from the background. A component of the media processing system (e.g., motion estimator 355 or an occlusion detection component) may also determine occlusion information for the objects displayed by the first set of pixels in the first frame and the third set of pixels in the Nth frame. That is, the media processing system may determine whether an object is blocked by another object in a particular key frame. Occlusion information may similarly be more accurate—e.g., because the objects are clearly separated from the background.

At block 430, a component of the media processing system (e.g., motion estimator 355 of FIG. 3) may estimate motion of objects in the masked key frames using the motion information determined for the first set of pixels in the first frame and the third set of pixels in the Nth frame. By estimating the motion of an object between the first and Nth frame, one motion estimate can be used for all of the intervening non-key frames. Also, occlusion detection based on consecutive key frames is more accurate than occlusion detection based on intervening non-key frames.

At block 435, a component of the media processing system (e.g., first motion compensator 360, second motion compensator 365, and/or Mth motion compensator 370 of FIG. 3) may compute segmentation maps for intervening non-key frames of the video file that occur between the first frame and the Nth frame. For example, the media processing system may use the first segmentation map, the Nth segmentation map, the motion information, and/or the occlusion information to compute a second segmentation map for an intervening non-key frame of the video file that is temporally located between the first frame and the Nth frame (e.g., the second frame immediately following the first frame). In some cases, computing the third segmentation map may include using the motion estimate to interpolate from the first segmentation map. Additionally or alternatively, computing the third segmentation map may include using the motion estimate to interpolate from the Nth segmentation map—e.g., if the media processing system determines an object is occluded in the first masked frame. In some examples, the media processing system may similarly compute a third segmentation map for a third frame that is temporally located between the first and Nth frame.

At block 440, a component of the media processing system may output a modified version of the media file based on the generated segmentation maps. For example, the media processing system may output a version of the media file where pixels in the first frame, second frame, third frame, and Nth frame that are associated with the first classification are displayed in color, while pixels in the in the first frame, second frame, third frame, and Nth frame that are associated with the first classification are displayed in black and white.

At block 445, of the modified version of the media file may be displayed at a device that includes the media processing system or at an external device.

Some of the features described above may be reordered or omitted. For example, the media processing system may refrain from performing the masking operation and compare the key frames directly to obtain a single motion estimate. In other examples, the media processing system may refrain from computing occlusion information.

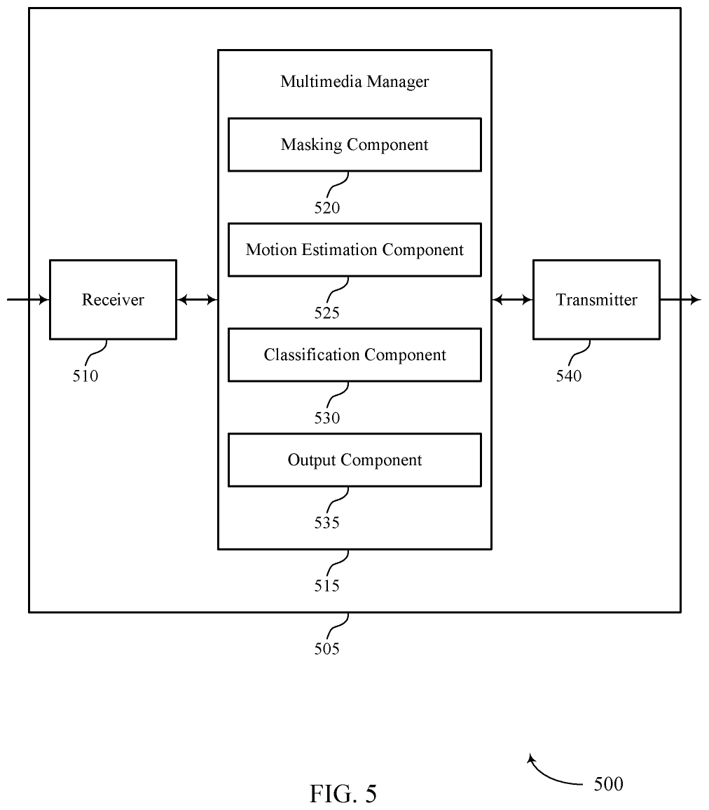

FIG. 5 shows a block diagram of an exemplary device that supports low-cost video segmentation as disclosed herein.

Block diagram 500 depicts device 505, which may be an example of aspects of a device 105, server 110, or network 120 of FIG. 1 or device 200 of FIG. 2. Device 505 may include receiver 510, multimedia manager 515, and transmitter 540. Device 505 may also include a processor, which may be an example of or include aspects of media processing system 300. Each of these components may be in communication with one another (e.g., via one or more buses).

Receiver 510 may receive information such as packets, user data, or control information associated with various information channels (e.g., control channels, data channels, and information related to low-cost video segmentation, etc.). Information may be passed on to other components of device 505. Receiver 510 may utilize a single antenna or a set of antennas.

Multimedia manager 515 may be configured to support low-cost video segmentation. Multimedia manager 515, or its sub-components, may be implemented in hardware, code (e.g., software or firmware) executed by a processor, or any combination thereof. If implemented in code executed by a processor, the functions of multimedia manager 515, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

Multimedia manager 515, or its sub-components, may be physically located at various positions, including being distributed such that portions of functions are implemented at different physical locations by one or more physical components. In some examples, multimedia manager 515, or its sub-components, may be a separate and distinct component in accordance with various aspects of the present disclosure. In some examples, multimedia manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Multimedia manager 515 may include masking component 520, motion estimation component 525, classification component 530, and output component 535. Masking component 520 may discard information for a first set of pixels in a first frame and a second set of pixels in a second frame based on a first segmentation map for the first frame and a second segmentation map for the second frame. Motion estimation component 525 may determine motion information for a third set of pixels in the first frame and a fourth set of pixels in the second frame based on the discarding. Classification component 530 may compute, based on the first segmentation map, the second segmentation map, and the motion information, a third segmentation map for a third frame that is temporally located between the first frame and the second frame. Output component 535 may output a modified version of the third frame based on the third segmentation map.

Transmitter 540 may transmit signals generated by other components of device 505. In some examples, transmitter 540 may be collocated with receiver 510 in a transceiver module. Transmitter 540 may utilize a single antenna or a set of antennas.

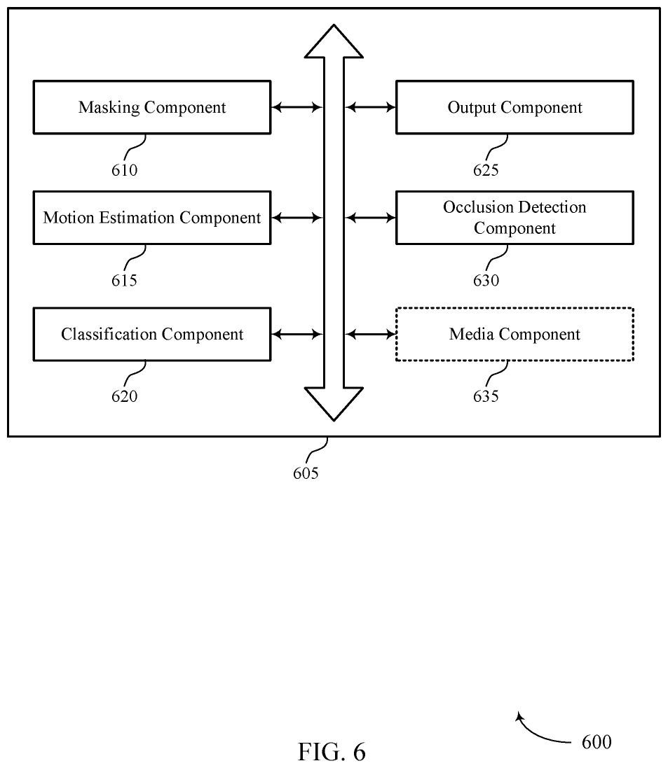

FIG. 6 shows a block diagram 600 of an exemplary multimedia manager that supports low-cost video segmentation as disclosed herein.

Multimedia manager 605 may be an example of or include aspects of multimedia manager 515 of FIG. 5 and media processing system 300 of FIG. 3. Multimedia manager 605 may include masking component 610, motion estimation component 615, classification component 620, output component 625, and occlusion detection component 630. Multimedia manager 605 may also include media component 635. Each of these modules may communicate, directly or indirectly, with one another (e.g., via one or more buses).

Media component 635 may be configured to obtain media files from internal memory or an external source (e.g., the cloud) and provide the media file to other components in multimedia manager 605. In some cases, media component 635 may be configured to store all or a portion of obtained media files. In some cases, the media file includes multiple frames (e.g., a video file).

Classification component 620 may be configured to compute a first segmentation map (e.g., segm_map_1) for a first frame of the multiple frames (e.g., Frame_1) and a second segmentation map (e.g., segm_map_N) for a second frame of the multiple frames (e.g., Frame_N). In some cases, in the first segmentation map, a first classification (e.g., “human”) is assigned to a third set of pixels of the first frame and a second classification (e.g., “background”) is assigned to a first set of pixels of the first frame. And, in the second segmentation map, the first classification is assigned to a fourth set of pixels of the second frame and the second classification is assigned to a second set of pixels of the second frame.

Masking component 610 may also be configured to compare the first segmentation map with the first frame and the second segmentation map with the second frame. In some cases, comparing the first segmentation map with the first frame and the second segmentation map with the second frame includes superimposing the first segmentation map over the first frame and the second segmentation map over the second frame.

Masking component 610 may also be configured to discard information for the first set of pixels in the first frame and the second set of pixels in the second frame based on the first segmentation map for the first frame and the second segmentation map for the second frame. In some cases, discarding the information for the first set of pixels in the first frame and the second set of pixels in the second frame is based on comparing the first segmentation map with the first frame and the second segmentation map with the second frame. For example, discarding the information for the first set of pixels and the second set of pixels may include discarding, in the first frame, pixels that do not overlap with pixels classified in the first segmentation map as the first classification, and in the second frame, pixels that do not overlap with pixels classified in the second segmentation map as the first classification. In another example, discarding the information for the first set of pixels and the second set of pixels may be based on determining that the first set of pixels of the first frame and the second set of pixels of the second frame are associated with the second classification. In some cases, masking component 610 is configured to determine that the first set of pixels of the first frame and the second set of pixels of the second frame are associated with the second classification based on the first segmentation map and the second segmentation map.

Motion estimation component 615 may be configured to determine motion information for the third set of pixels in the first frame and the fourth set of pixels in the second frame based on the discarding. In some cases, determining the motion information for the third set of pixels in the first frame and the fourth set of pixels in the second frame includes comparing information of the third set of pixels with information of the fourth set of pixels.

Motion estimation component 615 may also be configured to estimate, between the first frame and the second frame, a motion of an object (e.g., an identified human) displayed by the third set of pixels in the first frame and the fourth set of pixels in the second frame based on the motion information determined for the third set of pixels and the fourth set of pixels.

Occlusion detection component 630 may be configured to determine occlusion information for the third set of pixels in the first frame and the fourth set of pixels in the second frame based on the discarding. In some cases, determining the occlusion information for the third set of pixels in the first frame and the fourth set of pixels in the second frame includes comparing information of the third set of pixels with information of the fourth set of pixels.

Classification component 620 may also be configured to compute based on the first segmentation map, the second segmentation map, and the motion information, a third segmentation map (e.g., segm_map_3) for a third frame (e.g., Frame_2) that is temporally located between the first frame and the second frame. In some cases, computing the third segmentation map includes interpolating, from the first segmentation map or the second segmentation map, or both, the third segmentation map based on the estimated motion of the object. In some cases, the third segmentation map is computed based on the occlusion information.

Classification component 620 may also be configured to compute based on the first segmentation map, the second segmentation map, and the motion information, a fourth segmentation map (e.g., segm_map_M) for a fourth frame (e.g., Frame M) that is temporally located between the first frame and the second frame.

Output component 625 may be configured to output modified versions of the first frame and the second frame based on the first segmentation map and the second segmentation map. Output component 625 may also be configured to output modified version of the third frame based on the third segmentation map and the fourth frame based on the fourth segmentation map. In some cases, output component 625 may output the modified versions of the frames to a display component or device, which may display the modified versions of the frames to one or more users.

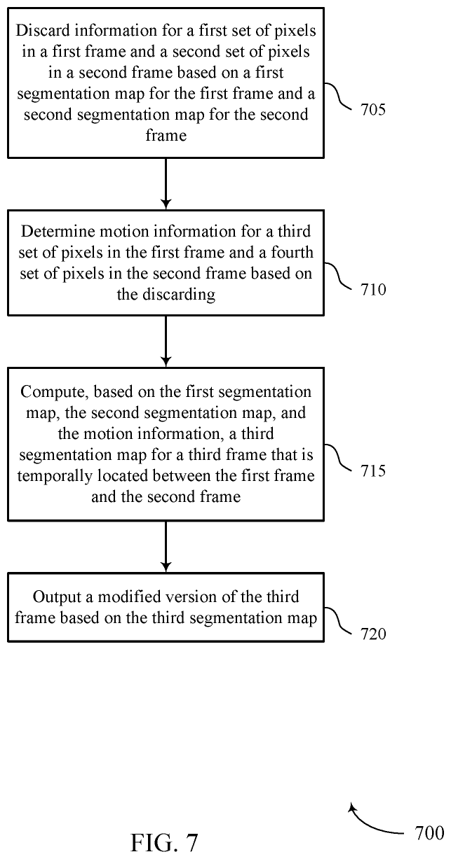

FIG. 7 shows a flowchart illustrating an exemplary method that supports low-cost video segmentation as disclosed herein.

The operations of method 700 may be implemented, in whole or in part, by a device 105, server 110, or network 120 of FIG. 1, device 200 of FIG. 2, or device 505 of FIG. 5, or their components as described herein. The operations of method 700 may also be performed by media processing system 300 of FIG. 3 or multimedia manager 515 or multimedia manager 605 of FIGS. 5 and 6. In some examples, a device may execute a set of instructions to control the functional elements of the device to perform the described functions. Additionally or alternatively, a device may perform aspects of the described functions using special-purpose hardware.

At block 705, the device may discard information for a first set of pixels in a first frame and a second set of pixels in a second frame based on a first segmentation map for the first frame and a second segmentation map for the second frame. The operations of 705 may be performed according to the methods described herein. In some examples, aspects of the operations of 705 may be performed by a masking component as described with reference to FIGS. 5 and 6.

At block 710, the device may determine motion information for a third set of pixels in the first frame and a fourth set of pixels in the second frame based on the discarding. The operations of 710 may be performed according to the methods described herein. In some examples, aspects of the operations of 710 may be performed by a motion estimation component as described with reference to FIGS. 5 and 6.

At block 715, the device may compute, based on the first segmentation map, the second segmentation map, and the motion information, a third segmentation map for a third frame that is temporally located between the first frame and the second frame. The operations of 715 may be performed according to the methods described herein. In some examples, aspects of the operations of 715 may be performed by a classification component as described with reference to FIGS. 5 and 6.

At block 720, the device may output a modified version of the third frame based on the third segmentation map. The operations of 720 may be performed according to the methods described herein. In some examples, aspects of the operations of 720 may be performed by an output component as described with reference to FIGS. 5 and 6.

It should be noted that the methods described herein describe possible implementations, and that the operations and the steps may be rearranged or otherwise modified and that other implementations are possible. Further, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RANI, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
discarding information for a first set of pixels in a first frame and a second set of pixels in a second frame based at least in part on a first segmentation map for the first frame and a second segmentation map for the second frame;
determining motion information for a third set of pixels in the first frame and a fourth set of pixels in the second frame based at least in part on the discarding;
computing, based at least in part on the first segmentation map, the second segmentation map, and the motion information, a third segmentation map for a third frame that is temporally located between the first frame and the second frame; and
outputting a modified version of the third frame based at least in part on the third segmentation map.

2. The method of claim 1, further comprising:
computing the first segmentation map for the first frame and the second segmentation map for the second frame, wherein, in the first segmentation map, a first classification is assigned to the third set of pixels of the first frame, and in the second segmentation map, the first classification is assigned to the fourth set of pixels of the second frame; and
comparing the first segmentation map with the first frame and the second segmentation map with the second frame, wherein discarding the information for the first set of pixels in the first frame and the second set of pixels in the second frame is based at least in part on the comparing.

3. The method of claim 2, wherein, in the first segmentation map, a second classification is assigned to the first set of pixels of the first frame, and in the second segmentation map, the second classification is assigned to the second set of pixels of the second frame, the method further comprising:
determining that the first set of pixels of the first frame and the second set of pixels of the second frame are associated with the second classification based at least in part on the first segmentation map and the second segmentation map, wherein discarding the information for the first set of pixels and the second set of pixels is based at least in part on the determining.

4. The method of claim 2, wherein:
comparing the first segmentation map with the first frame and the second segmentation map with the second frame comprises superimposing the first segmentation map over the first frame and the second segmentation map over the second frame, and
discarding the information for the first set of pixels in the first frame and the second set of pixels in the second frame comprises discarding, in the first frame, pixels that do not overlap with pixels classified in the first segmentation map as the first classification, and in the second frame, pixels that do not overlap with pixels classified in the second segmentation map as the first classification.

5. The method of claim 1, further comprising:
computing, based at least in part on the first segmentation map, the second segmentation map, and the motion information, a fourth segmentation map for a fourth frame that is temporally located between the first frame and the second frame.

6. The method of claim 1, further comprising:
estimating, between the first frame and the second frame, a motion of an object displayed by the third set of pixels in the first frame and the fourth set of pixels in the second frame based at least in part on the motion information determined for the third set of pixels and the fourth set of pixels;
wherein computing the third segmentation map comprises: interpolating the third segmentation map based at least in part on the estimated motion of the object; wherein the interpolation is from one or more of: the first segmentation map or the second segmentation map.

7. The method of claim 1, further comprising:
determining occlusion information for the third set of pixels in the first frame and the fourth set of pixels in the second frame based at least in part on the discarding, wherein the third segmentation map is computed based at least in part on the occlusion information.

8. The method of claim 7, wherein determining the motion information or the occlusion information, or both, for the third set of pixels in the first frame and the fourth set of pixels in the second frame comprises comparing information of the third set of pixels with information of the fourth set of pixels.

9. The method of claim 1, further comprising:
outputting modified versions of the first frame and the second frame based at least in part on the first segmentation map and the second segmentation map.

10. An apparatus, comprising:
a processor;
memory in electronic communication with the processor; and
instructions stored in the memory and executable by the processor to cause the apparatus to:
discard information for a first set of pixels in a first frame and a second set of pixels in a second frame based at least in part on a first segmentation map for the first frame and a second segmentation map for the second frame;
determine motion information for a third set of pixels in the first frame and a fourth set of pixels in the second frame based at least in part on the discarding;
compute, based at least in part on the first segmentation map, the second segmentation map, and the motion information, a third segmentation map for a third frame that is temporally located between the first frame and the second frame; and
output a modified version of the third frame based at least in part on the third segmentation map.

11. The apparatus of claim 10, wherein the instructions are further executable to cause the apparatus to:
compute the first segmentation map for the first frame and the second segmentation map for the second frame, wherein, in the first segmentation map, a first classification is assigned to the third set of pixels of the first frame, and in the second segmentation map, the first classification is assigned to the fourth set of pixels of the second frame; and
compare the first segmentation map with the first frame and the second segmentation map with the second frame, wherein discarding the information for the first set of pixels in the first frame and the second set of pixels in the second frame is based at least in part on the comparing.

12. The apparatus of claim 11, wherein the instructions are further executable to cause the apparatus to:
superimpose the first segmentation map over the first frame and the second segmentation map over the second frame, and
discard, in the first frame, pixels that do not overlap with the third set of pixels, and in the second frame, pixels that do not overlap with the fourth set of pixels.

13. The apparatus of claim 11, wherein the instructions are further executable to cause the apparatus to:
determining that the first set of pixels of the first frame and the second set of pixels of the second frame are associated with a second classification based at least in part on the first segmentation map and the second segmentation map.

14. The apparatus of claim 10, wherein the instructions are further executable to cause the apparatus to:
compute, based at least in part on the first segmentation map, the second segmentation map, and the motion information, a fourth segmentation map for a fourth frame that is temporally located between the first frame and the second frame.

15. The apparatus of claim 10, wherein the instructions are further executable to cause the apparatus to:
estimate, between the first frame and the second frame, a motion of an object displayed by the third set of pixels in the first frame and the fourth set of pixels in the second frame based at least in part on the motion information determined for the third set of pixels and the fourth set of pixels; and
interpolate, from the first segmentation map or the second segmentation map, or both, a movement of the object based at least in part on the estimated motion of the object.

16. The apparatus of claim 10, wherein the instructions are further executable to cause the apparatus to:
determine occlusion information for the third set of pixels in the first frame and the fourth set of pixels in the second frame based at least in part on the discarding.

17. A non-transitory computer-readable medium storing code, the code comprising instructions executable by a processor to:
discard information for a first set of pixels in a first frame and a second set of pixels in a second frame based at least in part on a first segmentation map for the first frame and a second segmentation map for the second frame;
determine motion information for a third set of pixels in the first frame and a fourth set of pixels in the second frame based at least in part on the discarding;
compute, based at least in part on the first segmentation map, the second segmentation map, and the motion information, a third segmentation map for a third frame that is temporally located between the first frame and the second frame; and
output a modified version of the third frame based at least in part on the third segmentation map.

18. The non-transitory computer-readable medium of claim 17, wherein the instructions are further executable by the processor to:
compute the first segmentation map for the first frame and the second segmentation map for the second frame, wherein, in the first segmentation map, a first classification is assigned to the third set of pixels of the first frame, and in the second segmentation map, the first classification is assigned to the fourth set of pixels of the second frame; and
compare the first segmentation map with the first frame and the second segmentation map with the second frame, wherein discarding the information for the first set of pixels in the first frame and the second set of pixels in the second frame is based at least in part on the comparing.

19. The non-transitory computer-readable medium of claim 18, wherein the instructions are further executable by the processor to:
superimpose the first segmentation map over the first frame and the second segmentation map over the second frame, and
discard, in the first frame, pixels that do not overlap with the third set of pixels, and in the second frame, pixels that do not overlap with the fourth set of pixels.

20. The non-transitory computer-readable medium of claim 17, wherein the instructions are further executable by the processor to:
compute, based at least in part on the first segmentation map, the second segmentation map, and the motion information, a fourth segmentation map for a fourth frame that is temporally located between the first frame and the second frame.
